(19) United States
(12) Patent Application Publication
(10) Pub. No.: US 2009/0072443 A1
(43) Pub. Date: Mar. 19, 2009

(54) PU ROLLER

(76) Inventors: Michael Wokurek, Wien (AT); Martin Breineder, Natschbach (AT)

Correspondence Address: Todd T. Taylor;Taylor & Aust, P.C., 142 S. Main Street, P.O. Box 560, Avilla, IN, 46710, US

(21) Appl. No.: 12/259,607

(22) Filed: Oct. 28, 2008

Related U.S. Application Data
(63) Continuation of application No. PCT/EP2007/051201, filed on Feb. 8, 2007.

(30) Foreign Application Priority Data
May 5, 2006 (DE) 10 2006 020 897.8

(51) Int. Cl. B28B 1/20; C08G 18/10; C08G 18/72; C08G 18/83

(52) U.S. Cl. 264/311; 528/59; 528/61; 528/64

(57) ABSTRACT

The invention relates to a method for producing a roller shell or roller lining of a roller made from a PPDI-based polyurethane plastic. The green strength shortcomings are to be overcome as quickly as possible to prevent stress cracks by the fact that the hardener added to the polyurethane shortens the working life to 5 to 60 seconds. The invention also relates to a PPDI polyurethane for the production of a roller shell or roller lining of a roller made by mixing a PPDI prepolymer with a hardener, in particular to carry out the method, wherein it is important that the hardener consists of 60 to 99% 1,4-butanediol, a maximum of 40% diamine, and at most 1% catalyst.

### CROSS REFERENCE TO RELATED APPLICATIONS

This is a continuation of PCT application No. PCT/EP2007/051201, entitled “PU ROLLER”, filed Feb. 8, 2007, which is incorporated herein by reference.

### BACKGROUND OF THE INVENTION

1. Field of the Invention

The invention relates to a method for manufacturing a roller sleeve or roller coating for a roller, made of a PPDI-based polyurethane plastic.

The invention further relates to a PPDI polyurethane for manufacturing a roller sleeve or roller coating for a roller, formed by mixing a PPDI prepolymer with a hardener.

2. Description of the Related Art

Polyurethane elastomers which are produced by a one- or two-stage reaction of PPDI (p-phenylene diisocyanate) with mixtures of polyols, diols, and diamines have been known for several decades.

PPDI polyurethane elastomers are characterized by high tear and tear propagation strength, high abrasion resistance, high hydrolytic resistance, and high elasticity.

However, hardening results in severe shrinkage and poor green strength.

What is needed in the art is to reduce the shrinkage and improve the green strength, thereby expanding the possible applications for the plastic.

### SUMMARY OF THE INVENTION

The present invention provides that the hardener added to the polyurethane shortens the pot life to 5 to 60 seconds (s).

As a result of the reduced pot life, the green strength shortcomings are rapidly overcome, thereby greatly decreasing the risk of stress cracks during curing of the plastic.

It is advantageous to shorten the pot life to 8 to 20 s, in particular 8 to 12 s.

Suitable selection of the hardener allows the reaction speed and the increase in viscosity in the course of the crosslinking reaction between the PPDI-based prepolymer and the hardener to be controlled in such a way that the roller sleeve or roller coating may be manufactured by rotary casting.

This is further assisted by the fact that, as the result of the accelerated crosslinking reaction, the period of time in which the pot material consistency is solid but lacking in great mechanical strength and elasticity is short.

The plastic is applied to a cylindrical, rotatably supported casting body using a casting nozzle which may be moved parallel to the axis of the casting body, the temperature of the applied plastic preferably being between 70 and 110° C.

To reduce the tendency of the applied plastic to form stress cracks during curing, the plastic should contain a catalyst which is preferably selected from the group of polyurethane (PU) polymerization catalysts. This group includes various organometallic compounds and salts of Zn, Co, Bi, Hg, Cd, K, and many others, for example the following: Dibutyltin dilaurate, tin octoate, dioctyltin diacetate, dibutyltin mercaptide, dibutyltin oxide, dimethyltin mercaptide, dioctyltin mercaptide, and dimethyltin carboxylate, etc., in addition to any tertiary amine, for example the following: Bis-(2-dimethylaminoethyl)ether, alkylmorpholine, 1,4-diazabicyclooctane, N,N-alkylbenzylamine, 1,2-dimethylimidazole, N,N-dimethylcyclohexylamine, and N,N,N′,N″-tetramethylethylenediamine.

In particular for casting of large hollow-cylindrical components such as press sleeves or roller coatings, it has proven to be advantageous when the circumferential speed of the casting body is between 15 and 80 m/min and the casting nozzle is axially moved at a speed between 5 and 10 mm/revolution.

To achieve good intermixture of the components, the mixing with the hardener should be carried out in a mixing chamber according to the rotor/stator principle.

It is advantageous for the rotor and stator to be designed in such a way that the following conditions are satisfied.

The gap width distribution between rotor and stator resulting from the design should be in the range of 1-5 mm and should be as narrow as possible in order to achieve the most uniform shear stress possible in the reaction mixture, thereby preventing plugging of the mixing chamber in areas with low shear velocity.

The dead volume in the mixing chamber should be as small as possible. Mixing chambers having a dead volume of 5 to 50 mL for intermixture of a material volume flow of 0.5 to 10 L/min have proven to be particularly satisfactory.

The resulting short residence times require very effective intermixture, which is achieved on the one hand by high rotor rotational speeds in the range of 1000 5000 rpm, and on the other hand by flow-dividing elements at the rotor and stator which prevent linear flow through the mixing chamber.

With regard to the PPDI polyurethane, it is essential to the invention that the hardener is composed of 60 to 99% 1,4-butanediol, a maximum of 40% diamine, and a maximum of 1% of a catalyst.

By use of such a hardener composition, the desired influencing of the reaction speed and the increase in viscosity in the course of the crosslinking reaction may be achieved in a particularly satisfactory manner.

It is advantageous for the hardener to contain at least 1% diamine and/or at least 0.01% of a catalyst.

The diamine in the hardener mixture is advantageously selected from the following group:

Diethyltoluenediamine, dimethylthiotoluenediamine, hexamethylenediamine, tetramethylenediamine, ethylenediamine, o-phenylenediamine, m phenylenediamine, p-phenylenediamine, 1,4-diaminocyclohexane, 1,2 diaminocyclohexane, 4,4′-diaminodiphenylmethane, isophoronediamine, 4,4′ diaminodicyclohexylmethane, 4,4′-methylene-bis-(3-chloroaniline), 4,4′ methylene-bis-(3-chloro-2,6-diethylaniline), trimethyleneglycol-di-p-aminobenzoate, 1,2-dis-(2-aminophenylthio)ethane, and 4,4′-diamino-3,3′-dimethyldicyclohexylmethane.

The PPDI prepolymer is advantageously selected from the following group of products from Crompton, or an equivalent product from another manufacturer: Adiprene LFP 590D, Adiprene LFP 950A, Adiprene LFP 850A, Adiprene LFP 1950A, Adiprene LFP 2950A.

The stoichiometry of the mixture, i.e., the molar ratio of the isocyanate fraction and the fraction of reactive hydrogen, should be between 0.85 and 1.15 to obtain an optimally balanced material property spectrum.

A roller sleeve or roller coating manufactured in this manner is very wear-resistant, capable of bearing high load, and long-lasting, and because of the high demands is suitable in particular for use as rollers in machines for manufacturing and/or processing a web made of paper, cardboard, tissue, or other fibrous material.

The hardness of the PPDI-polyurethanes should be between 80 Shore A and 75 Shore D.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a diagram of a schematic cross section of a casting apparatus.

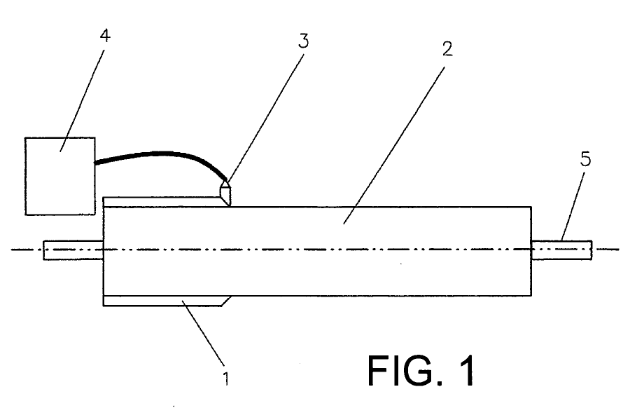

The exemplification set out herein illustrates one embodiment of the invention, and such exemplification is not to be construed as limiting the scope of the invention in any manner.

### DETAILED DESCRIPTION OF THE INVENTION

Referring now to the drawing, there is shown a plastic for forming a roller coating 1 which is applied to a rotatably supported casting body 2 in the form of a cylindrical roller base body in the rotary casting process.

This is achieved using a casting nozzle 3, designed as a slit die, which receives the molten plastic at a temperature between 70 and 90° C. from a mixing chamber 4.

The dynamic mixing chamber 4 operates according to the rotor/stator principle.

During the application the casting body 2 rotates at a preferably constant circumferential speed between 15 and 80 m/min. The casting nozzle 3 which is displaceable parallel to the rotational axis 5 of the casting body 2 is moved at a speed of 2 to 15, normally 5 to 10, mm/revolution so that a coating of uniform thickness is applied to the casting body 2.

The discharge rate of the casting nozzle 3 is between 500 and 10,000 g/min.

For manufacturing a roller coating 1 having maximum resistance, the plastic is composed of PPDI polyurethane, which is obtained by mixing a PPDI prepolymer with a hardener in the mixing chamber 4,

The hardener is intended to shorten the pot life to values between 8 and 12 s. This accelerated crosslinking allows use of the rotary casting process for the first time.

This is achieved by using a hardener composed of 92% 1,4-butanediol, 7.95% p phenylenediamine, and 0.05% dioctyltin mercaptide.

As the result of its extremely rapid reaction speed, the proportion of diamine determines the flow behavior of the plastic mixture at the time of exit from the casting nozzle 3 and in the first 2-5 seconds afterwards. This flow behavior is crucial for a successful process operation. Excessively low viscosity results in rapid runoff or castoff of the applied material, depending on the rotational speed and diameter of the rotating casting body 2, thereby limiting the achievable layer thickness. Excessively high viscosity prevents uniform flow of the plastic, resulting in an undesirable coarse surface structure (ribs) and air inclusions.

The catalyst subsequently causes the butanediol-isocyanate crosslinking reaction to proceed rapidly. The catalyst is thus responsible for a very brief period of pot material consistency (“cheesy” state/poor green strength) during which the workpiece is extremely susceptible to fatal stress cracks.

Only the combined use of both hardener components allows the flow behavior of the plastic mixture necessary for the rotary casting process to be adjusted while also ensuring an end product that is free of stress cracks.

The stoichiometry of the mixture is 95% (excess of isocyanate).

This is particularly advantageous in the manufacture of rollers for use in machines for manufacturing and/or processing a web made of paper, cardboard, tissue, or other fibrous material. Such rollers are exposed to very high stress, and have lengths of up to 10 m and diameters of up to 2 m.

The method and the plastic are likewise suited for manufacturing flexible roller sleeves. The roller sleeves are usually reinforced by fibers, threads, or the like embedded in the plastic, and are used primarily for dewatering or smoothing the web of fibrous material.

The roller sleeves are manufactured in an analogous manner by applying the plastic to a cylindrical casting body 2, but in this case the finished roller sleeve is pulled from the casting body 2, or the casting body 2 is removed from the cast roller sleeve.

Roller coatings 1 or roller sleeves manufactured in this manner are characterized by increased continuous load capacity with regard to line load and machine speed, and extension of the grinding intervals for machining the sleeve surface.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for manufacturing one of a roller sleeve and a roller coating for a roller, said method comprising the steps of:
making one of said roller sleeve and said roller coating of a p-phenylene diisocyanate-based polyurethane plastic; and
adding a hardener to a polyurethane, said hardener shortening a pot life to 5 to 60 seconds.

2. The method according to claim 1, wherein said pot life is shortened to 8 to 12 seconds.

3. The method according to claim 1, wherein the method of manufacturing is carried out using a rotary casting process.

4. The method according to claim 3, wherein said plastic is applied to a cylindrical, rotatably supported casting body using a casting nozzle which is configured for being moved parallel to an axis of said casting body.

5. The method according to claim 4, wherein a temperature of said plastic applied to said casting body is between 70 and 110° C.

6. The method according to claim 4, wherein said hardener includes a catalyst.

7. The method according to claim 4, wherein said hardener includes a catalyst which is from the group of polyurethane polymerization catalysts.

8. The method according to claim 4, wherein said hardener includes a catalyst which is formed from one of organometallic compounds, salts, and tertiary amines.

9. The method according to claim 4, wherein a circumferential speed of said casting body is between 15 and 80 meters/minute.

10. The method according to claim 4, wherein a casting nozzle is axially moved at a speed between 2 and 15 mm/revolution.

11. The method according to claim 4, wherein a casting nozzle is axially moved at a speed between 5 and 10 mm/revolution.

12. The method according to claim 1, wherein a mixing with said hardener is carried out in a mixing chamber according to a rotor/stator principle.

13. A p-phenylene diisocyanate polyurethane for manufacturing one of a roller sleeve and a roller coating for a roller, said p-phenylene diisocyanate polyurethane comprising:
a mixture of a p-phenylene diisocyanate prepolymer and a hardener, said hardener including 60 to 99% 1,4-butanediol, a maximum of 40% diamine, and a maximum of 1% of a catalyst, the p-phenylene diisocyanate polyurethane configured for being used to make one of the roller sleeve and said roller coating of a p-phenylene diisocyanate-based polyurethane plastic, said hardener configured for shortening a pot life to 5 to 60 seconds.

14. The p-phenylene diisocyanate polyurethane according to claim 13, wherein said hardener includes at least 1% diamine.

15. The p-phenylene diisocyanate polyurethane according to claim 13, wherein said hardener includes at least 0.01% of said catalyst.

16. The p-phenylene diisocyanate polyurethane according to claim 13, wherein said diamine is from the following group: Diethyltoluenediamine, dimethylthiotoluenediamine, hexamethylenediamine, tetramethylenediamine, ethylenediamine, o-phenylenediamine, m-phenylenediamine, p-phenylenediamine, 1,4-diaminocyclohexane, 1,2-diaminocyclohexane, 4,4′-diaminodiphenylmethane, isophoronediamine, 4,4′-diaminodicyclohexylmethane, 4,4′-methylene-bis-(3-chloroaniline), 4,4′-methylene-bis-(3-chloro-2,6-diethylaniline), trimethyleneglycol-di-p-aminobenzoate, 1,2-dis-(2-aminophenylthio)ethane, and 4,4′-diamino-3,3′-dimethyldicyclohexylmethane.

17. The p-phenylene diisocyanate polyurethane according to claim 13, wherein said catalyst is from the group of polyurethane polymerization catalysts.

18. The p-phenylene diisocyanate polyurethane according to claim 13, wherein said catalyst is formed from one of organometallic compounds, salts, and tertiary amines.

19. The p-phenylene diisocyanate polyurethane according to claim 13, wherein a mixing ratio of said prepolymer to said hardener corresponds to 85% to 115% stoichiometry.

20. The p-phenylene diisocyanate polyurethane according to claim 13, wherein a hardness is between 80 Shore A and 75 Shore D.

21. A method of using a roller, said method comprising the steps of:
providing that the roller includes one of a roller sleeve and a roller coating made of a p-phenylene diisocyanate-based polyurethane plastic and manufactured by adding a hardener to a polyurethane, said hardener shortening a pot life to 5 to 60 seconds; and
using the roller in a machine for at least one of manufacturing and processing a web of fibrous material.
